(19) United States
(12) Patent Application Publication
(10) Pub. No.: US 2004/0090999 A1
(43) Pub. Date: May 13, 2004

(54) Singal multiplexing circuit and optical communication system transmitter

(75) Inventor: Toshihide Suzuki, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/688,913

(22) Filed: Oct. 21, 2003

(30) Foreign Application Priority Data
Oct. 24, 2002 (JP) 2002-309751

(51) Int. Cl. H04J 3/02

(52) U.S. Cl. 370/537

(57) ABSTRACT

A signal multiplexing circuit includes a first selector circuit which multiplexes two data signals in synchronization with a first clock signal, a second selector circuit which multiplexes two data signals in synchronization with a second clock signal, and a clock control circuit which generates the first clock signal and the second clock signal as signals having a 90-degree phase shift relative to each other.

### CROSS-REFERENCE TO RELATED APPLICATIONS

The present application is based upon and claims the benefit of priority from the prior Japanese Patent Application No. 2002-309751 filed on Oct. 24, 2002, with the Japanese Patent Office, the entire contents of which are incorporated herein by reference.

### BACKGROUND OF THE INVENTION

1. Field of the Invention

The present invention generally relates to signal multiplexing circuits, and particularly relates to a signal multiplexing circuit which operates at high speed, and is used in a transmitter of an optical communication system or the like.

2. Description of the Related Art

A transmitter of an optical communication system multiplexes data signals by a signal multiplexing circuit, and modulates an optical signal based on the multiplexed data signals. The optical signal is then transmitted to a receiving end through an optical fiber. Such an optical communication system needs to operate at high speed at high frequencies. A signal multiplexing circuit is thus required that can operate with sufficient reliability at high frequencies.

FIG. 1 is a drawing showing the general construction of a transmitter of an optical communication system.

The optical communication system transmitter 10 of FIG. 1 includes a signal multiplexing circuit 11, a PLL circuit 12, an amplifier 13, a laser diode 14, and a modulator 15. The PLL circuit 12 performs phase-fixing through a feedback loop based on a reference clock signal RefCLK which is in synchronization with a data signal, thereby generating a clock signal CLK. The clock signal CLK is supplied to the signal multiplexing circuit 11.

The signal multiplexing circuit 11 receives N-channel input data, and multiplexes the input data based on the clock signal CLK. The multiplexed signal is amplified by the amplifier 13 and supplied to the modulator 15. The modulator 15 multiplexes laser light generated by the laser diode 14 according to the multiplexed signal supplied from the amplifier 13. The multiplexed signal is then transmitted to a receiving end through an optical fiber 16.

FIG. 2 is a circuit diagram showing an example of the construction of the related-art signal multiplexing circuit 11.

The signal multiplexing circuit 11 of FIG. 2 includes selector circuits 21 through 23, a toggle flip-flop 24, D latches 25 through 29, and buffers 30 through 34.

FIG. 3 is a signal timing diagram showing the operation of the signal multiplexing circuit 11 of FIG. 2. In the following, the operation of the circuit of FIG. 2 will be explained with reference to FIG. 3.

The frequency of the clock signal CLK shown in FIG. 3 (k) or (n) is divided by half by the toggle flip-flop 24, thereby generating a clock signal E shown in FIG. 3 (c) or (g). The clock signal E is supplied to the selector circuits 21 and 22. The data signals D1 and D3 (FIGS. 3 (a) and (b)) are input into the selector circuit 21 through the buffers 30 and 31, respectively, and are in synchronization with the clock signal E (FIG. 3 (c)). The selector circuit 21 selects data according to the clock signal E so as to generate a multiplexed signal A (FIG. 3 (d)), which includes the data signals D1 and D3 in a multiplexed form. Moreover, the data signals D2 and D4 (FIGS. 3 (e) and (f)) are input into the selector circuit 22 through the buffers 32 and 33, respectively, and are in synchronization with the clock signal E (FIG. 3 (g)). The selector circuit 22 selects data according to the clock signal E, and generates the multiplexing signal B (FIG. 3 (h)), which includes the data signals D2 and D4 in a multiplexed form.

The D latches 25 and 26, which receive the clock signal CLK as a timing signal, latch the multiplexed signal A (FIG. 3 (i)), thereby generating a multiplexed signal C (FIG. 3 (l)) that is in synchronization with the negative transition of the clock signal CLK (FIG. 3 (k)). Moreover, the D latches 27 through 29, which receive the clock signal CLK as a timing signal, latch the multiplexed signal B (FIG. 3 (j)), thereby generating a multiplexed signal D (FIG. 3 (m)) that is in synchronization with the positive transition of the clock signal CLK (FIG. 3 (k)). The multiplexed signals C and D generated in this manner are supplied to the selector circuit 23.

The selector circuit 23 selects data according to the clock signal CLK (FIG. 3 (n)) so as to generate the multiplexed signal Q (FIG. 3 (o)), which includes the multiplexed signals C and D in a further multiplexed form. In this manner, the multiplexed signal Q is obtained that includes the signals D1 through D4 multiplexed therein.

In the construction described above, the D latches 25 through 29 are provided for the purpose of generating the multiplexed signals C and D having a 90-degree phase shift relative to each other from the multiplexed signals A and B having the same phase. Such a 90-degree phase shift insures that a timing margin is provided for the signals C and D, which are to be selected by the selector circuit 23 in response to the clock signal CLK. With this provision, even if the phase timing of the clock signal CLK is advanced, for example, the signals can properly be multiplexed. It is possible to select the multiplexed signals A and B having the same phase in response to the clock signal CLK that has the edge timing aligned with these signals. In such a case, however, a slight displacement in the timing of the clock signal CLK will result in a failure to properly multiplex the signals. On the other hand, a sufficient timing margin is provided if the phases of the signals to be selected are displaced by 90 degrees with each other as shown in the construction of FIG. 2. This achieves reliable data multiplexing even when high-speed operation is required.

Although FIG. 2 and FIG. 3 show a specific example of a circuit that multiplexes the four data signals D1 through D4, any number of data signals can be multiplexed in the same manner. For example, two circuits identical to the signal multiplexing circuit shown in FIG. 2 may be arranged side by side, each multiplexing four data signals, with the two resulting signals being selected by a 2-to-1 selector circuit. This achieves 8-to-1 multiplexing. In such a case, a D latch which carries out 90-degree phase adjustment may be provided at a stage preceding the 2-to-1 selector circuit situated at the last stage.

Further, as an example of the parallel-to-serial conversion of digital data, Japanese Patent Application Publication No. 9-6591 discloses a parallel-to-serial conversion circuit that is capable of high-speed operations.

The signal multiplexing circuit 11 described above needs five D latches, which results in commensurate increases in the power consumption and circuit size. These D latches are required to operate reliably at high speed. Also, it is necessary to attend to timing alignment with the clock signal CLK at the next processing stage as these D latches cause signal delays.

Accordingly, there is a need for a signal multiplexing circuit which is capable of reliable high-speed operations while reducing power consumption and circuit size to a minimum.

### SUMMARY OF THE INVENTION

It is a general object of the present invention to provide a signal multiplexing circuit that substantially obviates one or more problems caused by the limitations and disadvantages of the related art.

Features and advantages of the present invention will be presented in the description which follows, and in part will become apparent from the description and the accompanying drawings, or may be learned by practice of the invention according to the teachings provided in the description. Objects as well as other features and advantages of the present invention will be realized and attained by a signal multiplexing circuit particularly pointed out in the specification in such full, clear, concise, and exact terms as to enable a person having ordinary skill in the art to practice the invention.

To achieve these and other advantages in accordance with the purpose of the invention, the invention provides a signal multiplexing circuit, including a first selector circuit which multiplexes two data signals in synchronization with a first clock signal, a second selector circuit which multiplexes two data signals in synchronization with a second clock signal, and a clock control circuit which generates the first clock signal and the second clock signal as signals having a 90-degree phase shift relative to each other.

The signal multiplexing circuit described above uses the clock signals having a 90-degree phase shift relative to each other, so that there is no need to provide D latches for creating a 90-degreee phase shift as in the related-art construction. This makes it possible to make commensurate reduction in power consumption and circuit size while providing a 90-degree phase shift for the signals to be selected. A timing margin is thus provided, achieving reliable data multiplexing for high-speed operations.

Further, a transmitter for an optical communication system according to the invention includes a signal multiplexing circuit, an amplifier which amplifies an output of the signal multiplexing circuit, and a modulator which modulates an optical signal according to an output of the amplifier, wherein the signal multiplexing circuit includes a first selector circuit which multiplexes two data signals in synchronization with a first clock signal, a second selector circuit which multiplexes two data signals in synchronization with a second clock signal, and a clock control circuit which generates the first clock signal and the second clock signal as signals having a 90-degree phase shift relative to each other.

The transmitter for an optical communication system as described above can reduce power consumption and circuit size while providing a timing margin, thereby achieving reliable data multiplexing for high speed operations.

Other objects and further features of the present invention will be apparent from the following detailed description when read in conjunction with the accompanying drawings.

### BRIEF DESCRIPTION OF THE DRAWINGS

FIG. 1 is a drawing showing the general construction of a transmitter of an optical communication system;

FIG. 2 is a circuit diagram showing an example of the construction of a related-art signal multiplexing circuit;

FIG. 3 is a signal timing diagram showing the operation of the signal multiplexing circuit of FIG. 2;

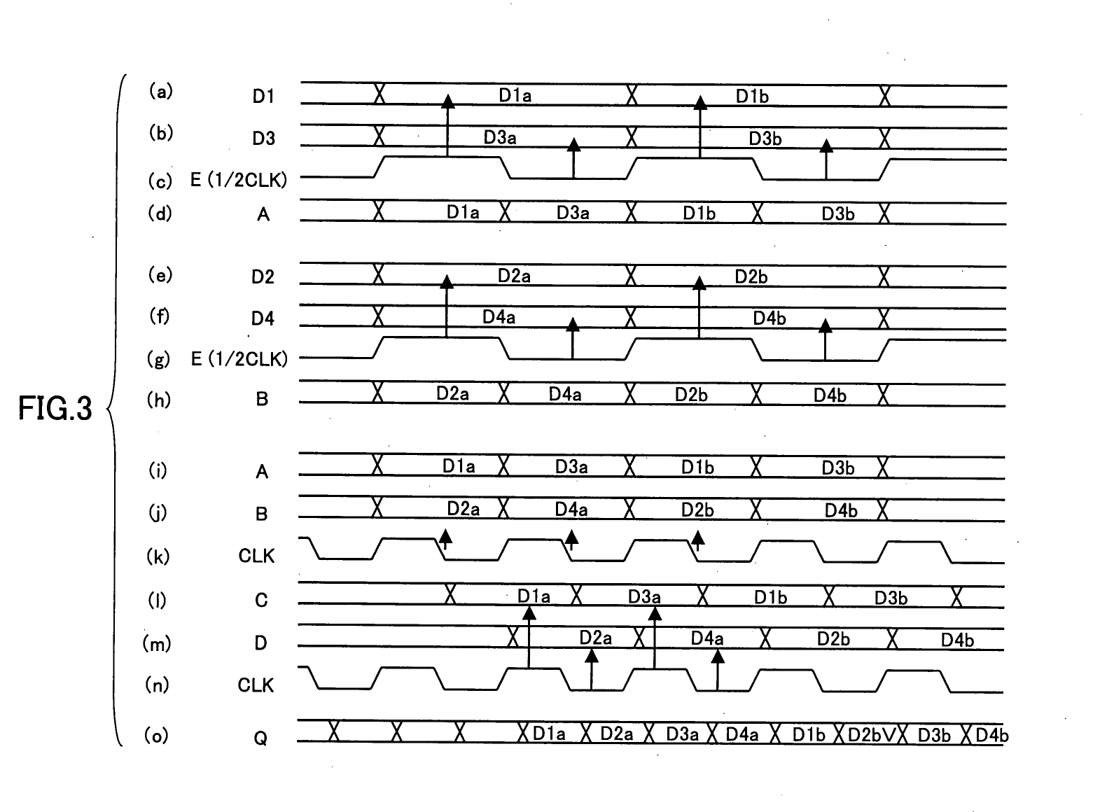

FIG. 4 is a circuit diagram showing an example of the construction of a signal multiplexing circuit according to the invention;

FIG. 5 is a signal timing diagram showing the operation of the signal multiplexing circuit of FIG. 4;

FIG. 6 is a circuit diagram showing an example of the construction of a toggle flip-flop used in the signal multiplexing circuit of FIG. 4;

FIG. 7 is a chart showing the relationship between a clock signal and the two clock outputs of the toggle flip-flop;

FIG. 8 is a circuit diagram showing a variation of the construction of the signal multiplexing circuit according to the invention;

FIG. 9 is a circuit diagram showing another embodiment of the signal multiplexing circuit according to the invention;

FIG. 10 is a drawing showing the construction of a circuit that has a re-timer in addition to the related-art signal multiplexing circuit of FIG. 2; and

FIG. 11 is a drawing showing the construction of a circuit that has a re-timer in addition to the signal multiplexing circuit of the invention shown in FIG. 4.

### DESCRIPTION OF THE PREFERRED EMBODIMENTS

In the following, embodiments of the present invention will be described with reference to the accompanying drawings.

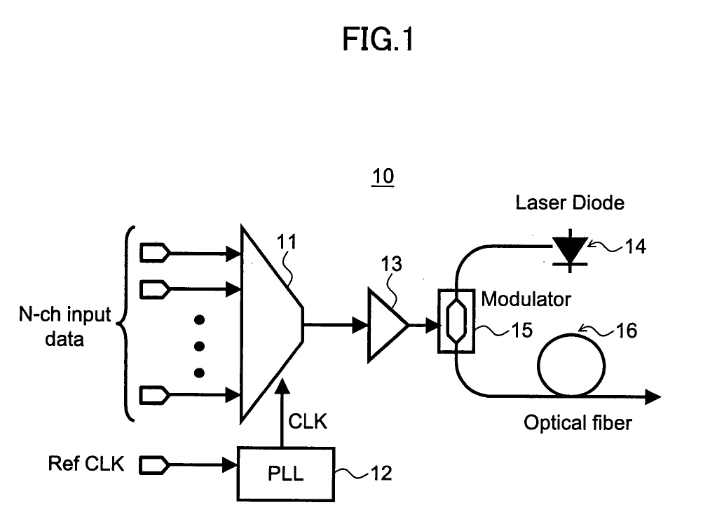

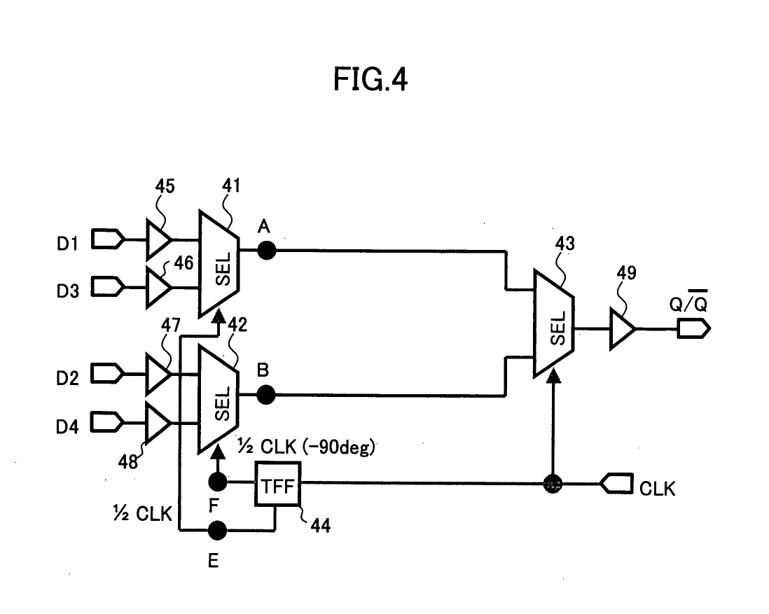

FIG. 4 is a circuit diagram showing an example of the construction of a signal multiplexing circuit according to the invention. This signal multiplexing circuit is used as the signal multiplexing circuit of the optical communication system transmitter 10 shown in FIG. 1, for example.

The signal multiplexing circuit of FIG. 4 includes selector circuits 41 through 43, a toggle flip-flop 44, and buffers 45 through 49.

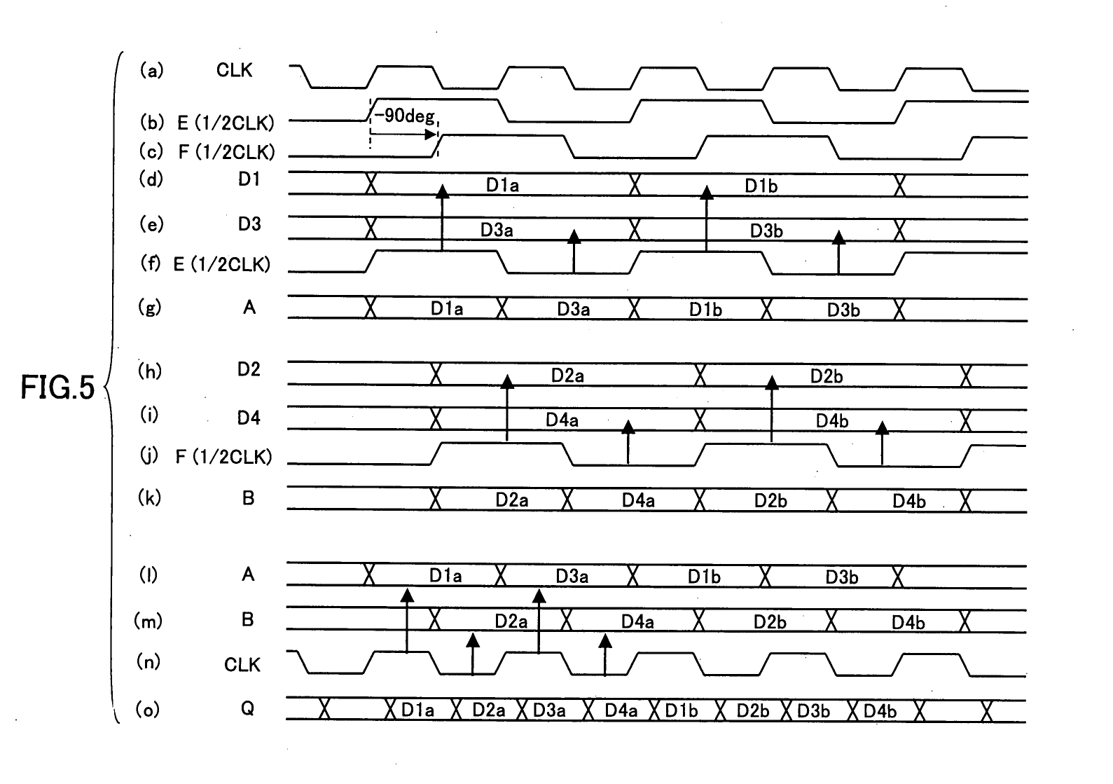

FIG. 5 is a signal timing diagram showing the operation of the signal multiplexing circuit of FIG. 4. In what follows, the operation of the circuit of FIG. 4 will be described with reference to FIG. 5.

The frequency of the clock signal CLK shown in FIG. 5 (a) is divided by half by the toggle flip-flop 44, which generates a clock signal E (FIG. 5 (b)) having an in-phase relationship with the clock signal CLK. Also, a clock signal F (FIG. 5 (c)) having a 90-degree phase shift relative to the clock signal E is generated. The clock signal E is supplied to the selector circuit 41, and the clock signal F is supplied to the selector circuit 42. Data signals D1 and D3 (FIGS. 5 (d) and (e)) are input into the selector circuit 41 through buffers 45 and 46, respectively, and are in synchronization with the clock signal E (FIG. 5 (f)). The selector circuit 41 selects data according to the clock signal E so as to generate a multiplexed signal A (FIG. 5 (g)), which includes the data signals D1 and D3 in a multiplexed form. Moreover, data signals D2 and D4 (FIGS. 5 (h) and (i)) are input into the selector circuit 42 through buffers 47 and 48, respectively, and are in synchronization with the clock signal F (FIG. 5 (j)). The selector circuit 42 selects data according to the clock signal F so as to generate a multiplexed signal B (FIG. 5 (k)), in which the data signals D2 and D4 were multiplexed.

The multiplexed signals A and B generated in this manner have a 90-degree phase shift relative to each other, and are supplied to the selector circuit 43.

The selector circuit 43 selects data according to the clock signal CLK (FIG. 5 (n)), thereby generating a multiplexed signal Q (FIG. 5 (o)), in which the multiplexed signals A and B are further multiplexed. In this manner, the multiplexed signal Q, in which the signals D1 through D4 are multiplexed, is obtained. In the construction described above, the toggle flip-flop 44 generates the clock signals E and F having a 90-degree phase shift relative to each other, and the selector circuits 41 and 42 select data in response to these clock signals so as to generate the multiplexed signals A and B, which have a 90-degree phase shift relative to each other. Such a 90-degree phase shift provides a timing margin for the signals A and B, which are to be selected by the selector circuit 43 in response to the clock signal CLK. As a result, even if the phase timing of this clock signal CLK is advanced, for example, the signals can properly be multiplexed. Reliable data multiplexing is thus attained even when high-speed operations are required.

Although FIG. 4 and FIG. 5 show a specific example of a circuit that multiplexes the four data signals D1 through D4, any number of data signals can be multiplexed in the same manner. For example, two circuits identical to the signal multiplexing circuit shown in FIG. 4 may be arranged side by side, each multiplexing four data signals, with the two resulting signals being selected by a 2-to-1 selector circuit. This achieves 8-to-1 multiplexing. In such a case, the clock signals having a 90-degree phase shift relative to each other may be employed as such a need arises in the 2-to-1 selector circuit situated at the last stage.

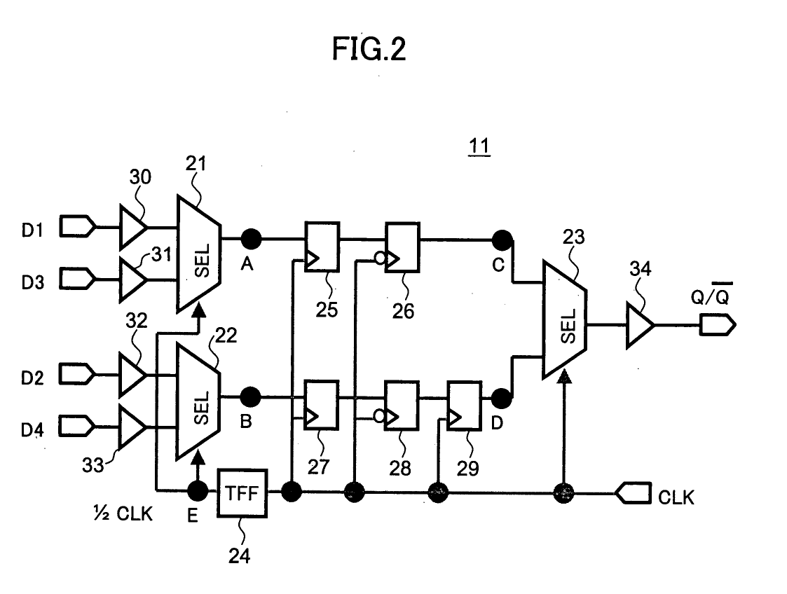

The signal multiplexing circuit according to the present invention uses the clock signals having a 90-degree phase shift relative to each other, so that there is no need to provide the D latches 25 through 29 for creating a 90-degreee phase shift as shown in FIG. 2. This makes it possible to make commensurate reduction in the power consumption and circuit size while providing a 90-degree phase shift for the signals to be selected. A timing margin is thus provided, achieving reliable data multiplexing for high-speed operations.

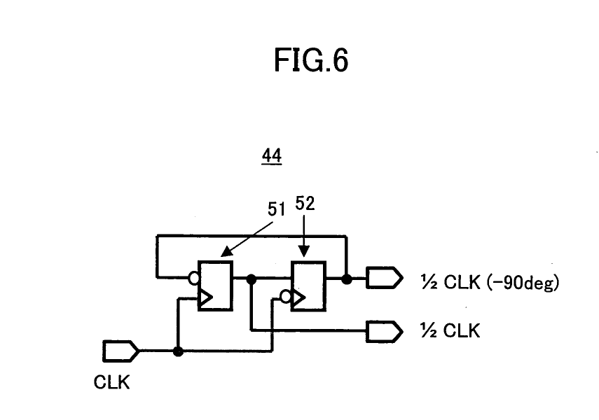

FIG. 6 is a circuit diagram showing an example of the construction of the toggle flip-flop 44 used in the signal multiplexing circuit of FIG. 4.

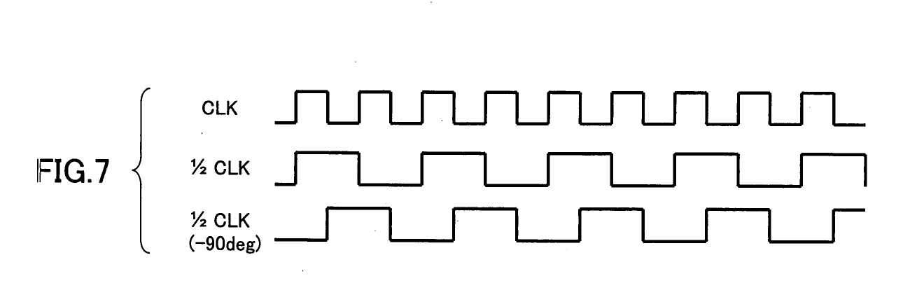

The toggle flip-flop 44 of FIG. 6 includes D latches 51 and 52. The D latch 51 receives the clock signal CLK as a clock input for a rising-edge trigger, and the D latch 52 receives the clock signal CLK as a clock input for a falling-edge trigger. The output of the D latch 52 is supplied to the D latch 51 as a reversal input. With this construction, the toggle flip-flop 44 performs a toggle operation that inverts its output once in every clock cycle, thereby functioning to provide ½ frequency division of the clock signal CLK. Moreover, the output signal of the D latch 51 and the output signal of the D latch 52 are given a 90-degree phase shift relative to each other. The output of the D latch 51 corresponds to the clock signal E, and the output of the D latch 52 corresponds to the clock signal F. FIG. 7 shows the relationship between the clock signal CLK and the two clock outputs of the toggle flip-flop 44.

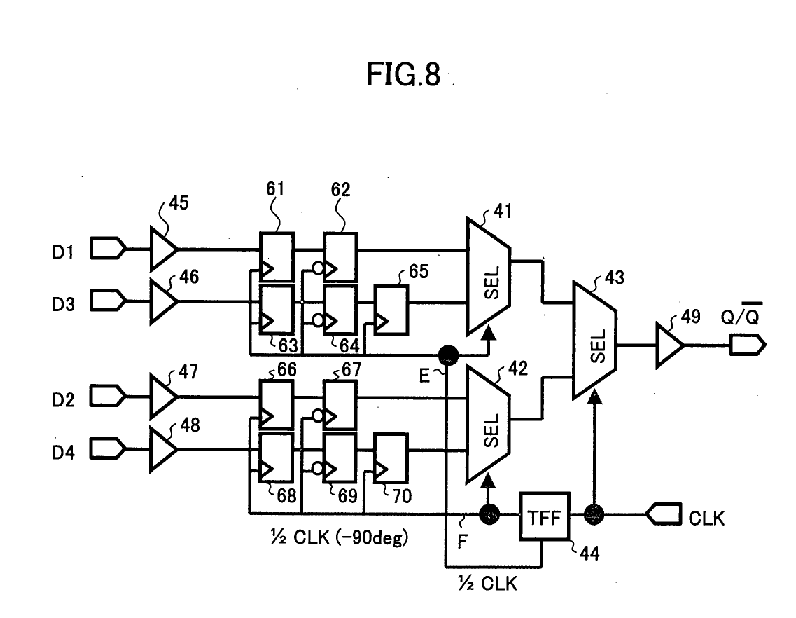

FIG. 8 is a circuit diagram showing a variation of the construction of the signal multiplexing circuit according to the invention. In FIG. 8, the same elements as those of FIG. 4 are referred to by the same numerals, and a description thereof will be omitted.

A signal multiplexing circuit of FIG. 8 includes D latches 61 through 70 in addition to the construction of the signal multiplexing circuit of FIG. 4.

The D latches 61 through 65 constitute a data timing adjustment circuit, which adjusts phases in order to provide a relative phase shift for the data signals D1 and D3 which have the same phase. Specifically, the clock signal E is supplied as a clock input to the D latch 61, and is also supplied as a reversed clock input to the D latch 62. A series connection of the D latches 61 and 62 provides for the data signal D1 to be latched at a positive transition of the clock signal E and to be output at a negative transition of the clock signal E. By the same token, the D latches 63 and 64 latch the data signal D3 at a positive transition of the clock signal E, and output it at a negative transition of the clock signal E. This output is then aligned with a positive transition of the clock signal E by the D latch 65. As a result, the data signal D1 is placed in synchronization with the positive transition of the clock signal E, and the data signal D3 is placed in synchronization with the negative transition of the clock signal E.

The D latches 66 through 70 constitute a data timing adjustment circuit, which adjusts phases in order to provide a relative phase shift for the data signals D2 and D4 which have the same phase. These circuits perform phase adjustments on input data signals in the same manner as the D latches 25 through 29 in the related-art construction of FIG. 2 provide a 90-degree phase shift for the multiplexed signals.

With the construction of FIG. 4, the selector circuit 41, which multiplexes the data signals D1 and D3, require precise timing alignment since the data signals D1 and D3 and the clock signal E have aligned edge timing. The same applies in the case of the selector circuit 42, which multiplexes the data signals D2 and D4. That is, precise timing alignment is necessary since the data signals D2 and D4 and the clock signal F have aligned edge timing.

In the construction of FIG. 8, on the other hand, the data signals D1 and D3 multiplexed by the selector circuit 41 are given a relative phase shift, and, also, the data signals D2 and D4 multiplexed by the selector circuit 42 are given a relative phase shift, thereby creating a timing margin. This achieves reliable multiplexing even when high-speed operations are performed. In comparison with the construction of FIG. 4, the construction of FIG. 8 has an increased circuit size and increased power consumption. However, if a comparison is made with a construction having a phase adjustment circuit additionally provided for the data signals D1 through D4 in FIG. 2, circuit size and power consumption are reduced as the D latches 25 through 29 are not in existence.

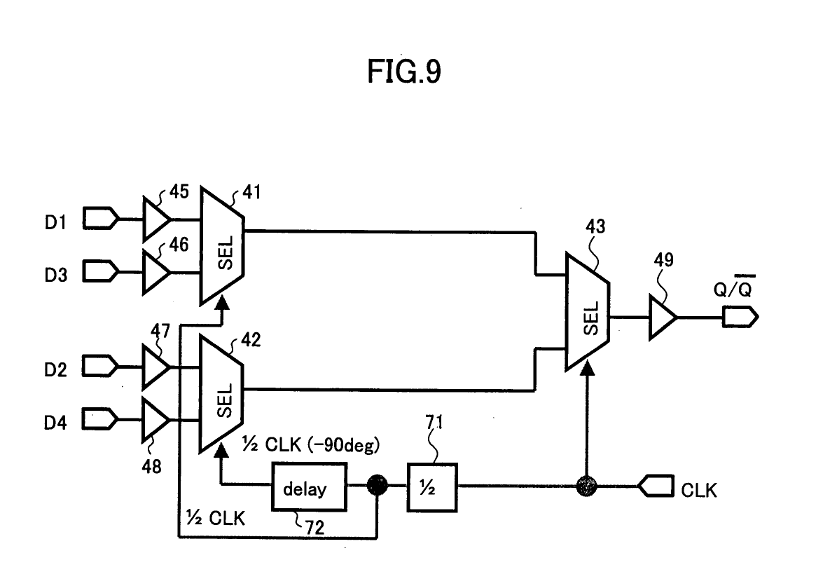

FIG. 9 is a circuit diagram showing another embodiment of the signal multiplexing circuit according to the invention. In FIG. 9, the same elements as those of FIG. 4 are referred to by the same numerals, and a description thereof will be omitted.

The circuit of FIG. 9 includes a ½-frequency-division circuit 71 and a delay circuit 72 in place of the toggle flip-flop 44 of FIG. 4. The ½-frequency-division circuit 71 divides the frequency of the clock signal CLK by half, thereby generating a clock signal having half the frequency. The delay circuit 72 delays the clock signal having half the frequency by a predetermined time length, thereby generating a clock signal having a 90-degree phase shift. That is, the delay of the delay circuit 72 is set equal to ¼ of the clock cycle of the clock signal having half the frequency.

The construction of FIG. 9 can generate a 90-degree phase shift by use of the delay circuit 72 comprised of simple delay elements. Since the delay time of the delay circuit 72 is fixed, however, this construction is not applicable to a system that changes clock cycles.

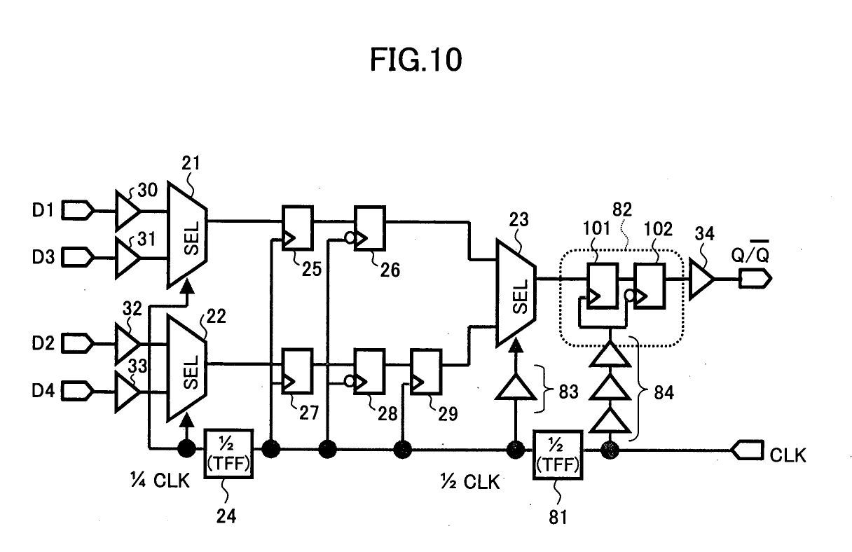

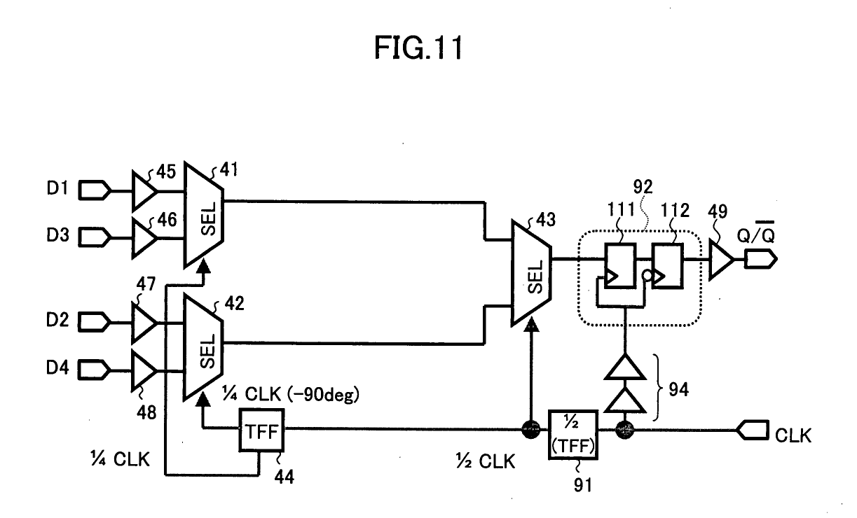

FIG. 10 is a drawing showing the construction of a circuit that has a re-timer in addition to the related-art signal multiplexing circuit of FIG. 2. FIG. 11 is a drawing showing the construction of a circuit that has a re-timer in addition to the signal multiplexing circuit of the invention shown in FIG. 4. In these constructions having an additional re-timer, further differences arise in power consumption and circuit size between the related-art signal multiplexing circuit and the signal multiplexing circuit of the invention.

The timing of an output signal may be not aligned with the clock signal CLK which defines timing. In such a case, a re-timer circuit serves to align the timing of the output signal to the clock signal CLK at the output node. In the related-art construction of FIG. 10, the clock signal CLK which is input into a ½-frequency divider 81 is supplied to the re-timer circuit 82, whereby the timing of the output signal of the selector circuit 23 is aligned to the clock signal CLK. The re-timer circuit 82 includes the D latches 101 and 102, and is configured to latch the output signal at the edge timing of the clock signal CLK. In the related-art construction shown in FIG. 10, a buffer 83 is provided on the path through which the clock signal is input into the selector circuit 23, taking into consideration the delay of the incoming signal to the selector circuit 23. Further, buffers 84 are provided on the clock input path coupled to the re-timer circuit 82, taking into consideration the delay of the selector circuit 23.

FIG. 11 shows the construction of a circuit that has a re-timer provided in addition to the signal multiplexing circuit of the invention of FIG. 4. In the construction of the invention shown in FIG. 11, the clock signal CLK which is input into a ½-frequency divider 91 is supplied to a re-timer circuit 92, whereby the timing of the output signal of the selector circuit 43 is aligned to the clock signal CLK. The re-timer circuit 92 includes the D latches 111 and 112, and is configured to latch the output signal at the edge timing of the clock signal CLK.

In the construction of the invention shown in FIG. 11, the signals input into the selector circuit 43 have no delays. There is thus no need to provide a buffer for timing adjustment like the buffer 83 of FIG. 10 on the clock input path coupled to the selector circuit 43. Consequently, the number of buffers 94, which are provided on the clock input path coupled to the re-timer circuit 92 in order to absorb the delay caused by the selector circuit 43, can be reduced by one as compared with the number of the buffers 84 of FIG. 10. In the construction of FIG. 10, a buffer for absorbing the delay of the signals input into the selector circuit 23 needs to be inserted into each of the clock input paths coupled to the selector circuit 23 and the re-timer circuit 82, respectively. In the construction of FIG. 11, on the other hand, there is no delay in the signals input into the selector circuit 43, thereby eliminating a need for a buffer that would absorb this delay that did not exist. Accordingly, the construction of FIG. 11 can reduce the number of buffers by one on each of the clock input paths coupled to the selector circuit 43 and the re-timer circuit 92, respectively, in comparison with the number of buffers required in the construction of FIG. 10.

In this manner, the construction of the invention can further reduce power consumption and circuit size in comparison with the related-art signal multiplexing circuit when re-timer circuits are additionally provided.

Further, the present invention is not limited to these embodiments, but various variations and modifications may be made without departing from the scope of the present invention.

What is claimed is:

1. A signal multiplexing circuit, comprising:
a first selector circuit which multiplexes two data signals in synchronization with a first clock signal;
a second selector circuit which multiplexes two data signals in synchronization with a second clock signal; and
a clock control circuit which generates the first clock signal and the second clock signal as signals having a 90-degree phase shift relative to each other.

2. The signal multiplexing circuit as claimed in claim 1, further comprising a third selector circuit which multiplexes an output of said first selector circuit and an output of said second selector circuit in synchronization with a third clock signal.

3. The signal multiplexing circuit as claimed in claim 2, wherein said clock control circuit generates the first clock signal and the second clock signal from the third clock signal such that the first clock signal and the second clock signal have half a frequency of the third clock signal.

4. The signal multiplexing circuit as claimed in claim 3, wherein said clock control circuit includes:
a first latch circuit which receives the third clock signal as a clock input; and
a second latch circuit which receives the third clock signal as a reversed clock input, and receives an output of said first latch circuit as data input,
wherein an inverse of an output of said second latch circuit is input into said first latch circuit as data input, the first clock signal being the output of said first latch circuit, and the second clock signal being the output of said second latch circuit.

5. The signal multiplexing circuit as claimed in claim 3, wherein said clock control circuit includes:
a circuit which generates the first clock signal by dividing a frequency of the third clock signal by half; and
a delay circuit which delays the first clock signal by a predetermined time length.

6. The signal multiplexing circuit as claimed in claim 3, further comprising:
a first data-timing adjustment circuit which shifts phases of the two data signals input into said first selector circuit; and
a second data-timing adjustment circuit which shifts phases of the two data signals input into said second selector circuit.

7. The signal multiplexing circuit as claimed in claim 6, wherein said first data-timing adjustment circuit attends to timing adjustment based on the first clock signal, and said second data-timing adjustment circuit attends to timing adjustment based on the second clock signal.

8. A transmitter for an optical communication system, comprising:
a signal multiplexing circuit;
an amplifier which amplifies an output of said signal multiplexing circuit; and
a modulator which modulates an optical signal according to an output of said amplifier, wherein said signal multiplexing circuit includes:
a first selector circuit which multiplexes two data signals in synchronization with a first clock signal;
a second selector circuit which multiplexes two data signals in synchronization with a second clock signal; and
a clock control circuit which generates the first clock signal and the second clock signal as signals having a 90-degree phase shift relative to each other.

9. The transmitter as claimed in claim 8, wherein said signal multiplexing circuit further includes a third selector circuit which multiplexes an output of said first selector circuit and an output of said second selector circuit in synchronization with a third clock signal.

10. The transmitter as claimed in claim 8, wherein said clock control circuit generates the first clock signal and the second clock signal from the third clock signal such that the first clock signal and the second clock signal have half a frequency of the third clock signal.
